(19) United States
(12) Patent Application Publication
(10) Pub. No.: US 2006/0107008 A1
(43) Pub. Date: May 18, 2006

(54) Apparatus and method for augmenting information security through the use of location data

(76) Inventors: Adel Ghanem, Danville, CA (US); James T. Busse, Belmont, CA (US); Greg Arnold, Sunnyvale, CA (US); Glen Kuo, Los Altos, CA (US)

Correspondence Address: COOLEY GODWARD, LLP, 3000 EL CAMINO REAL, 5 PALO ALTO SQUARE, PALO ALTO, CA, 94306, US

(21) Appl. No.: 10/993,407

(22) Filed: Nov. 18, 2004

(51) Int. Cl. G06F 12/14

(52) U.S. Cl. 711/163

(57) ABSTRACT

An apparatus for controlling data access includes a monitor to track the physical location of data. A data access module enables access to the data when the physical location satisfies location criteria. A data blocking module disables access to the data when the physical location fails to satisfy location criteria.

### BRIEF DESCRIPTION OF THE INVENTION

This invention relates generally to information security. More particularly, this invention relates to the use of location data to enhance information security.

### BACKGROUND OF THE INVENTION

Recent studies show that up to 30% of public sector laptop computers contain sensitive data and up to 15% of the laptop computers stolen by criminals were taken with the intent to sell the data stored on the computers. Information technology managers face serious challenges in providing a secure computing environment for users who demand mobile access to sensitive company data in a wide range of environments, such as the office, home, field office, or client location. Allowing users to access sensitive data in all of these environments while protecting the data in transit or when the asset is stolen is a difficult challenge.

There are various techniques to provide information security. For example, encryption or proprietary data channels may be used for information security. Unfortunately, there are a variety of shortcomings associated with existing techniques. For example, encryption techniques are attackable through applied mathematics. As processor power increases, the likelihood of successful applied mathematical attacks increases. Another problem with existing systems is that data that is protected is typically transferred over the same channel as the keys, creating bottlenecks and usage delays. These delays can create problems, such as the re-broadcasting of encrypted data, which allows cracking, observation, and even corruption of the data.

In view of the foregoing, it would be highly desirable to provide an improved technique for information security. Ideally, the technique would augment existing techniques and would rely upon location data.

### SUMMARY OF THE INVENTION

The invention includes an apparatus for controlling data access. A monitor tracks the physical location of data. A data access module enables access to the data when the physical location satisfies location criteria. A data blocking module disables access to the data when the physical location fails to satisfy location criteria.

The invention also includes a method of controlling data access. The physical location of data is monitored. Access to the data is enabled when the physical location satisfies location criteria. Access to the data is disabled when the physical location fails to satisfy location criteria.

The invention provides an efficient, robust and cost-effective technique to limit access to secure data based on user location or proximity to a particular location. The invention protects against unauthorized data access in stolen assets, enabling the reporting of entry and exit of mobile assets and making possible system configuration based on location information. By combining currently available encryption technology with location information, access to encrypted files can be denied unless the user is in a location deemed to be valid for that user (e.g., in the office, at a client site, or at home). Encrypted files cannot be accessed if the user is outside of these defined locations. Further, removal of the monitor automatically disables access to any encrypted or secured data. In addition, location information can be used to automatically alter the configuration of the target system.

### BRIEF DESCRIPTION OF THE FIGURES

The invention is more fully appreciated in connection with the following detailed description taken in conjunction with the accompanying drawings, in which:

FIG. 1 illustrates a physical location monitor configured in accordance with an embodiment of the invention.

FIG. 2 illustrates a computing device configured in accordance with an embodiment of the invention.

FIG. 3 illustrates processing operations associated with an embodiment of the invention.

FIG. 4 illustrates a first wireless network architecture implementing an embodiment of the invention.

FIG. 5 illustrates a second wireless network architecture implementing an embodiment of the invention.

FIG. 6 illustrates a wired network architecture implementing an embodiment of the invention.

Like reference numerals refer to corresponding parts throughout the several views of the drawings.

### DETAILED DESCRIPTION OF THE INVENTION

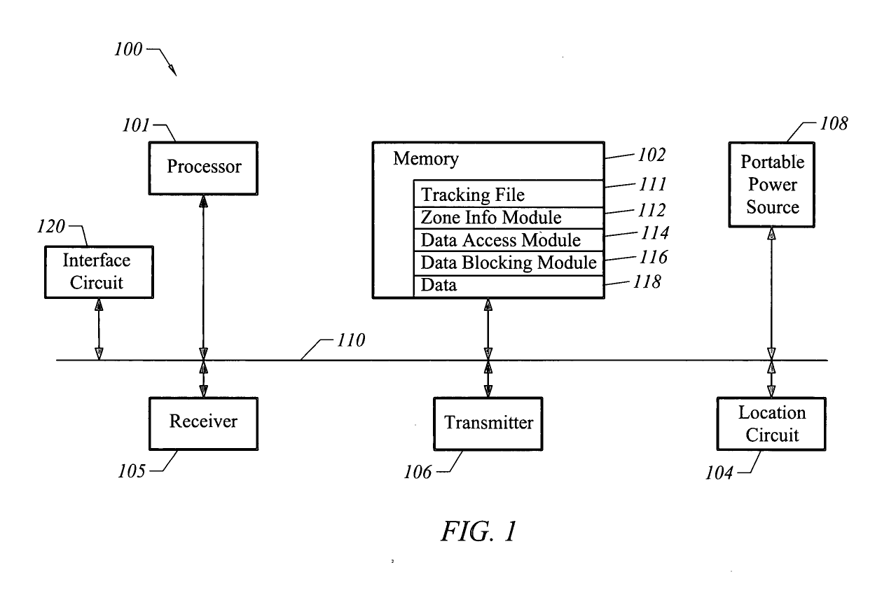

FIG. 1 illustrates circuitry for a monitor 100. The monitor 100 may also be referred to as a portable location device or a tag. In accordance with one embodiment of the invention, the monitor 100 includes an address/data bus 110 for communicating information, a processor 101 coupled with the bus 110 for processing information and instructions, and a memory unit 102 coupled with the bus 110 for storing data and executable instructions. The memory 102 may comprise volatile memory (e.g., random access memory (RAM), static RAM, dynamic Ram, and the like) and/or non-volatile memory (e.g., read only memory (ROM), programmable ROM, flash memory, EPROM, EEPROM, hard drives, removable disks, and the like).

The monitor 100 further comprises a location circuit 104 (e.g., a Global Positioning System (GPS) Circuit) coupled to a bus 110. Location circuit 104 is operable to determine the geographic location of the monitor 100 based on a system of satellites that orbit the earth. It should be appreciated that location circuits, such as GPS circuits are well known in the art, and that any such circuits can be implemented in the monitor 100. Further, in one embodiment of the invention, the location circuit is implemented to monitor the location of the monitor with respect to a fixed point in space or with respect to multiple fixed points in space. This implementation can be in lieu of or in combination with the GPS functionality. Monitor 100 further comprises wireless receiver 105 for receiving communications and wireless transmitter 106 for transmitting communications. In one embodiment, receiver 105 is operable to receive information from a wireless network and transmitter 106 is operable to transmit information to the wireless network, as further discussed below. It should be appreciated that receiver 105 and transmitter 106 may be integrated into a single component, such as a transceiver circuit.

Monitor 100 further comprises a portable power source 108. Portable power source 108 can comprise, for example, primary or rechargeable batteries, a fuel cell, a photovoltaic panel, a radio-isotope thermal electric generator and the like. Portable power source 108 provides electrical energy for the operation of the monitor 100. Preferably, the monitor is also configured to receive power from another computing device to which it may be attached. Standard interfaces may be used to accomplish this functionality.

The memory 102 stores data and executable programs. For example, the memory 102 may store a tracking file 111, which stores monitor location information as a function of time. The memory 102 may also store a zone information module 112 that specifies geographic zones and then determines whether the monitor 100 is in a defined geographic zone. Thus, the zone information module may include stored data specifying, for example “safe” and “unsafe” zones, and then may test these zones with current physical location data to determine whether the monitor satisfies location criteria specified by the zone information. If location criteria are satisfied, a positive location criteria signal is generated to indicate this fact. In one embodiment of the invention, the positive location criteria signal is then processed by a data access module 114, which facilitates access to data 118. The data 118 may be stored in the monitor 100, but more commonly the data is stored in a computing device associated with the monitor 100. If location criteria are not satisfied, then a negative location criteria signal is generated to indicate this fact. In one embodiment of the invention, a data blocking module 116 is used to process the negative location criteria signal to prohibit access to data, as further discussed below.

FIG. 1 also illustrates an interface circuit 120. The interface circuit 120 facilitates connection to another computing device. The interface circuit 120 may facilitate a wireless connection to a computing device or a wired connection, such as through a serial port, parallel port, standard interface, or proprietary interface.

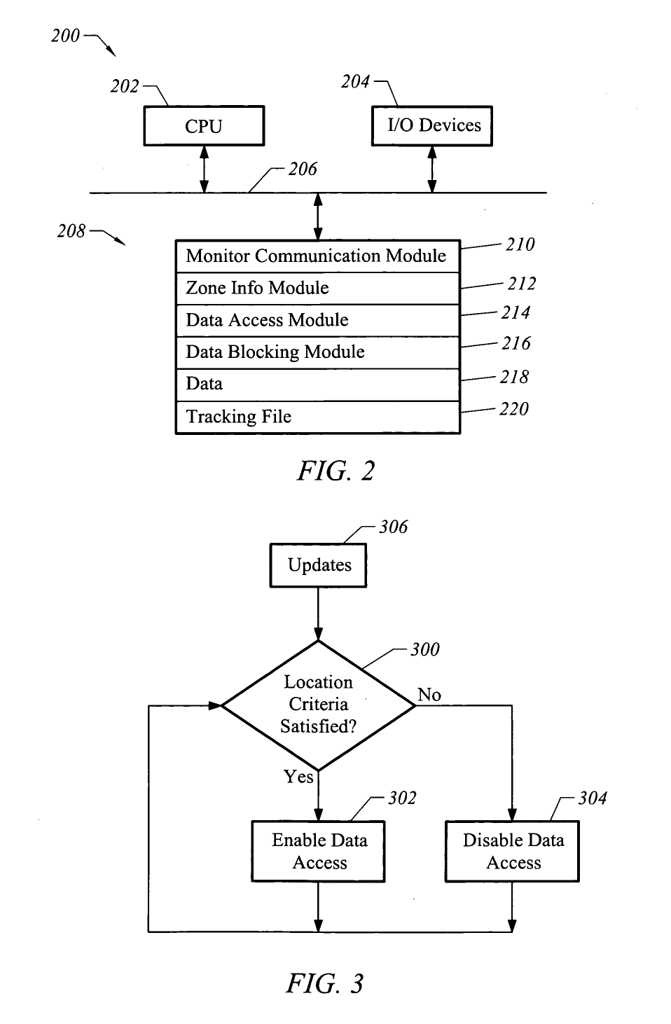

FIG. 2 illustrates a computing device 200 that may be used in accordance with an embodiment of the invention. The computing device 200 may be a personal computer, personal digital assistant, and the like. By way of example, computing device 200 includes a central processing unit 202 connected to a set of input/output devices 204 via a bus 206. The input/output devices may include a keyboard, mouse, touch screen, liquid crystal display, printer, wired and wireless network links, and the like. The input/output devices 204 may also include a serial port, parallel port, standard interface or proprietary interface to the monitor 100. This interface may be a physical connection or a wireless connection.

A memory 208 is also connected to the bus 206. The memory 208 stores data and executable programs. For example, the memory 208 stores a monitor communication module 210, which is used to facilitate wired or wireless communications with a monitor 100. The memory 208 may also store a zone information module 210. The zone information module 212 may correspond to the zone information module 112. Alternately, zone information modules 112 and 212 may contain different types of information. In this embodiment, the monitor 100 sends current location information to the computing device 200 and the computing device 200 determines whether the physical location of the monitor 100 satisfies location criteria. If so, the zone information module 212 generates a positive location criteria signal, if not the module 212 generates a negative location criteria signal.

Computing device 200 may process the positive location criteria signal with a data access module 214. The data access module 214 enables access to data 218. The negative location criteria signal may be processed by the data blocking module 216, which blocks access to data 218. Thus, data access and data blocking functions may be implemented either at the monitor 100 or at the computation device 200.

The memory 208 of the computing device 200 may also store a tracking file 220. The tracking file 220 corresponds to the tracking file 111. Thus, in accordance with the invention, the tracking information may be stored at the monitor 100 and/or at the computing device 200.

FIG. 3 illustrates processing operations associated with an embodiment of the invention. First, a determination is made whether location criteria is satisfied 300. The zone information module 112 or the zone information module 212 or some combination thereof may make this determination. In one embodiment of the invention, at least two conditions are checked: (1) whether the monitor is linked physically or wirelessly to the computing device 200 and (2) whether the monitor is physically located within specified locations. If both conditions are satisfied, then data access is enabled 302. Data access may be enabled through any of a variety of techniques, including decrypting the data or establishing a physical, logical or electronic link to a memory storing the data. If both conditions are not satisfied, then data access is disabled 304. Data access maybe disabled through any of a variety of techniques, including encrypting or establishing a physical, logical, or electronic disconnect with a memory storing the data.

FIG. 3 also illustrates that updates 306 may be provided to inform the decision of whether the location criteria are satisfied. For example, the updates 306 may include new information specifying “safe” and “unsafe” physical locations. These updates may be generated by a security service, which delivers the updates by wired or wireless transmission mediums, as further discussed below.

The monitor 100 of the invention is configured to detect any attempt to remove the monitor from a computing device. The invention may also include a secure, wireless communication network between monitors. For example, access points may provide a mechanism by which a monitor can report unauthorized events (such as monitor removal or asset entry or exit from a location) and download information necessary to permit valid access of data.

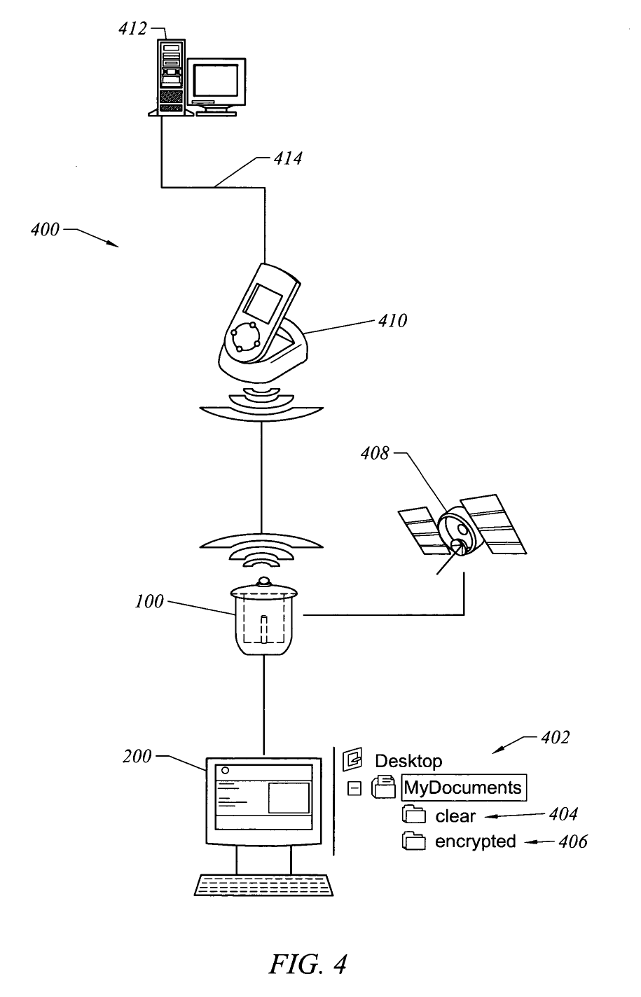

FIG. 4 illustrates a wireless network 400 configured in accordance with an embodiment of the invention. The network 400 includes a monitor 100, which is attached to a computing device 200, using either a wired or wireless link. In the case of a wired link, a serial port, parallel port, standard interface or proprietary interface may be used. If the wired or wireless link between the monitor 100 and the computing device 200 is ever broken, then data access is preferably blocked. Any number of techniques may be used to track the wired or wireless link between the monitor 100 and the computing device 200.

In an alternate embodiment of the invention, the monitor 100 is installed within the computing device 200. Those skilled in the art will appreciate that various engineering design tradeoffs are available in configuring the size of the monitor 100. For example, the type of interface circuit 120 used for the monitor will dictate certain form factors for the monitor 100.

FIG. 4 illustrates that the computing device 200 has an associated graphical user interface 402 that indicates whether the data is accessible (i.e., clear) 404 or is not accessible (e.g., encrypted) 406. As previously indicated, the computing device 200 may be used to perform known encryption and decryption operations based upon the location of the monitor 100. The monitor 100 itself may be used to perform these operations as well, but such a configuration naturally entails a larger and more powerful computing platform for the monitor 100. In many embodiments of the invention, it will be more convenient to rely upon the computing device 200 to perform data intensive operations, such as encrypting and decrypting.

The monitor 100 communicates with a positioning service 408. By way of example, the positioning service 408 may be a Global Positioning System positioning service. The positioning service may be wireless or may come from another wired connection that would contain the position information.

FIG. 4 also illustrates a local access point 410. The local access point 410 is used to support wireless communications with the monitor 100. As previously indicated, the monitor 100 includes a receiver 105 and transmitter 106 to communicate with a local access point 410. A security service 412 may be used to transfer location criteria to the computing apparatus 200 or to the monitor 100. For example, an employer operating the security service 412 may specify permitted physical locations for an employee to access data. This information may then be downloaded to the monitor 100 and/or computing device 200. In one embodiment, the location of the monitor 100 is tracked in reference to the local access point 410 or a number of local access points.

In an application where the local access point 410 is a separate component of the invention, the local access point 410 may be used to receive information from one medium (e.g., wire) and transfer it to the same or different (e.g., wireless) medium. The local access point 410 may be internal to the monitor 100 or may be internal to the computing apparatus 200.

The link 414 transfers information between the local access point 410 and the security service 412. This link may be wired or wireless. In one embodiment of the invention, this is the logical or physical link that transmits permitted locations, encrypted data, decrypted data, encryption/decryption keys and other information to the local access point 410, the monitor 100, and/or the computing device 200.

The security service 412 may be used to transfer encrypted information, clear information, encryption keys, and decryption keys. Additionally, the security service 412 may provide location keys and encryption services that change or alter the clear information into encrypted information. Further, the security service 412 may be used to automatically set configurable parameters based upon physical location.

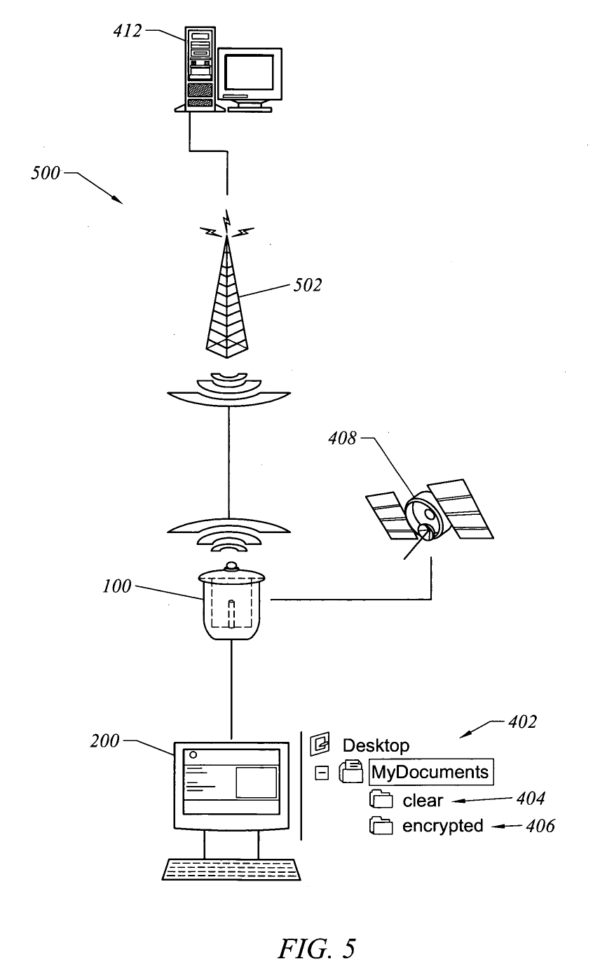

FIG. 5 illustrates an alternate embodiment of the invention. The network 500 of FIG. 5 generally corresponds to the network 400 of FIG. 4, but in the network 500 the local access point 410 is substituted with a wide area wireless network service 502.

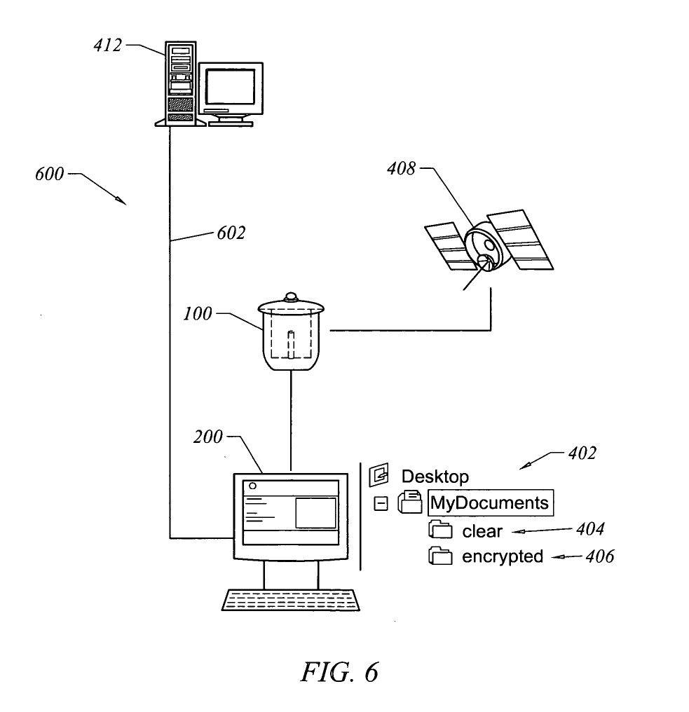

FIG. 6 illustrates an alternate network 600 configured in accordance with an embodiment of the invention. In this configuration, wireless communication links between the security service 412 and the computing device 200 are replaced by a wired connection 602. This wired connection may be any Internet dial-up, broadband, or other physical link. In this configuration, the security service 412 is available to directly provide encryption keys, data and the like.

The invention may be implemented using the technology described in any one of the following patent applications. Each of these patent applications is commonly assigned to the assignee of the present invention. Each of these patent applications is incorporated herein by reference.

System and Method of Marking Regions for a Portable Locating Device, Ser. No. 10/780,368, filed on Feb. 17, 2004.

Receiver Device and Method Using GPS Baseband Correlator Circuitry for Despreading both GPS and Local Wireless Baseband Signals, Ser. No. 10/703,348, filed on Nov. 7, 2003.

A Finder Device for Locating a Tag Device, Ser. No. 10/752,155, filed on Jan. 5, 2004.

System and Method of Power Management for a Portable Locating Device, Ser. No. 60/617,509, filed on Oct. 8, 2004.

System and Method of Indicating a Direction to an Intelligent Object, Ser. No. 60/617,572, filed on Oct. 8, 2004.

A Method and Device for Transmitting Data at High Data Rates Using a Modulated Spreading Code, Ser. No. 10/931,078, filed on Aug. 30, 2004.

A Method for Determining and Using Optimal Synchronization Words, Ser. No. 10/801,428, filed on Mar. 15, 2004.

The application entitled “System and Method of Marking Regions for a Portable Locating Device”, Ser. No. 10/780,368, filed on Feb. 17, 2004, describes a technique for using a monitor to define safe and unsafe physical locations. Thus, this technique may be used in accordance with an embodiment of the invention. Alternately, safe and unsafe physical locations may be defined at the computing device 200 and or the security service 412.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. An apparatus for controlling data access, comprising:
a monitor to track the physical location of data;
a data access module to enable access to said data when said physical location satisfies location criteria; and
a data blocking module to disable access to said data when said physical location fails to satisfy location criteria.

2. The apparatus of claim 1 wherein said monitor is a portable location device associated with a computing device storing said data.

3. The apparatus of claim 2 wherein said monitor is a portable location device physically connected to said computing device.

4. The apparatus of claim 3 wherein said monitor is a portable location device physically connected to a serial, parallel, standard or proprietary interface of said computing device.

5. The apparatus of claim 2 wherein said monitor is a portable location device wirelessly linked to said computing device.

6. The apparatus of claim 1 wherein said data access module decrypts said data.

7. The apparatus of claim 1 wherein said data access module establishes a physical, logical, or electronic link to a memory storing said data.

8. The apparatus of claim 1 wherein said data blocking module encrypts said data.

9. The apparatus of claim 1 wherein data blocking module establishes a physical, logical, or electronic disconnect with a memory storing said data.

10. The apparatus of claim 1 wherein said location criteria include a designated physical region.

11. The apparatus of claim 1 wherein said location criteria include a physical link between a portable location device and a computing device storing said data.

12. The apparatus of claim 1 wherein said location criteria include a wireless link between a portable location device and a computing device storing said data.

13. The apparatus of claim 1 wherein said location criteria is stored within a computing device storing said data.

14. The apparatus of claim 13 wherein selected location criteria are received from a security service.

15. The apparatus of claim 14 wherein said selected location criteria are received over a network connection.

16. The apparatus of claim 14 wherein said selected location criteria are received over a wireless connection.

17. The apparatus of claim 1 wherein selected location criteria are received at a portable location device.

18. The apparatus of claim 17 wherein said selected location criteria are received over a wireless connection.

19. A method of controlling data access, comprising:
monitoring the physical location of data;
enabling access to said data when said physical location satisfies location criteria; and
disabling access to said data when said physical location fails to satisfy location criteria.

20. The method of claim 19 wherein monitoring is performed through a portable location device associated with a computing device storing said data.

21. The method of claim 20 wherein monitoring is performed through a portable location device physically connected to said computing device.

22. The method of claim 21 wherein monitoring is performed through a portable location device physically connected to a serial, parallel, standard or proprietary interface of said computing device.

23. The method of claim 20 wherein monitoring is performed through a portable location device wirelessly linked to said computing device.

24. The method of claim 19 wherein enabling access to said data includes decrypting said data.

25. The method of claim 19 wherein enabling access to said data includes establishing a physical, logical, or electronic link to a memory storing said data.

26. The method of claim 19 wherein disabling access to said data includes encrypting said data.

27. The method of claim 19 wherein disabling access to said data includes establishing a physical, logical, or electronic disconnect with a memory storing said data.

28. The method of claim 19 further comprising defining said location criteria to include a designated physical region.

29. The method of claim 19 further comprising defining said location criteria to include a physical link between a portable location device and a computing device storing said data.

30. The method of claim 19 further comprising defining said location criteria to include a wireless link between a portable location device and a computing device storing said data.

31. The method of claim 19 further comprising storing said location criteria at a computing device storing said data.

32. The method of claim 31 further comprising receiving selected location criteria from a security service.

33. The method of claim 32 further comprising receiving said selected location criteria over a network connection.

34. The method of claim 32 further comprising receiving said selected location criteria over a wireless connection.

35. The method of claim 19 further comprising receiving selected location criteria at a portable location device.

36. The method of claim 35 further comprising receiving said selected location criteria over a wireless connection.
